(19) United States
(12) Patent Application Publication
(10) Pub. No.: US 2021/0347270 A1
(43) Pub. Date: Nov. 11, 2021

(54) TRANSIENT HEAT STORAGE FOR DC CHARGE INLET CONNECTOR ASSEMBLY

(71) Applicant: Yazaki North America, Inc., Canton, MI (US)

(72) Inventors: Bryan Donald Cole, Whitmore Lake, MI (US); Marcellus Richard Shantz, Ypsilanti, MI (US)

(73) Assignee: Yazaki North America, Inc., Canton, MI (US)

(21) Appl. No.: 17/379,491

(22) Filed: Jul. 19, 2021

Related U.S. Application Data
(60) Provisional application No. 63/053,982, filed on Jul. 20, 2020.

(51) Int. Cl. B60L 53/18; H01R 13/506; H01R 4/64

(52) U.S. Cl. CPC B60L 53/18; H01R 2201/26; H01R 4/646; H01R 13/506

(57) ABSTRACT

A connector assembly for a vehicle charging system includes a first housing defining a charge port of the vehicle charging system and a second housing coupled to the first housing. The second housing is configured to receive an electrical wire including a power terminal therein. The connector assembly further includes a flexible tube coupled to the second housing and a phase change material disposed therein. The phase change material is configured to surround at least a portion of the electrical wire. The phase change material is configured to store heat energy from at least one of the electrical wire or the power terminal. The connector assembly further includes a cover coupled to the second housing for facilitating the injection of the phase change material into the flexible tube.

### CROSS-REFERENCE TO RELATED APPLICATIONS

This application claims the benefit of and priority to U.S. Provisional Patent Application No. 63/053,982, filed Jul. 20, 2020, the contents of which are incorporated herein by reference in its entirety.

### BACKGROUND

The present disclosure relates generally to vehicle charging systems. More specifically, the present disclosure relates to a transient heat storage connector assembly for a vehicle charging system.

### SUMMARY

At least one embodiment relates to a connector assembly for a vehicle charging system. The connector assembly includes a first housing defining a charge port of the vehicle charging system and a second housing coupled to the first housing. The second housing is configured to receive an electrical wire including a power terminal therein. The connector assembly further includes a flexible tube coupled to the second housing and a phase change material disposed therein. The phase change material is configured to surround at least a portion of the electrical wire. The phase change material is configured to store heat energy from at least one of the electrical wire or the power terminal. The connector assembly further includes a cover coupled to the second housing for facilitating the injection of the phase change material into the flexible tube.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a transient heat storage connector assembly, according to an exemplary embodiment.

FIG. 2 is a cross-sectional view of the transient heat storage connector assembly of FIG. 1.

FIG. 3 is a perspective view of a power terminal of the transient heat storage connector assembly of FIG. 1.

FIG. 4 is a perspective view of an inlet eyelet terminal of the transient heat storage connector assembly of FIG. 1.

FIGS. 5 and 6 are perspective views of a cover of the transient heat storage connector assembly of FIG. 1.

FIG. 7 is a cross-sectional view of the transient heat storage connector assembly of FIG. 1.

FIG. 8 is a perspective view of a battery eyelet terminal of the transient heat storage connector assembly of FIG. 1.

FIGS. 9 and 10 are perspective views of a battery attachment of the transient heat storage connector assembly of FIG. 1.

FIG. 11 is a schematic of the transient heat storage connector assembly of FIG. 1.

FIG. 12 is a flow chart of a method of assembling the transient heat storage connector assembly of FIG. 1.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

During charging of a fully or partially electrically-powered vehicle, a charger plug of an external power source is coupled to a charge port of a connector of the vehicle charging system, allowing current to flow between the external power source and a battery of the vehicle. During “fast-charging” situations, higher rates of power, current, and/or voltage that exceed the rated amounts for the wires/terminals of the connector may be used. These higher rates of current can, however, result in excessive heat being generated at the connector, which can decrease the efficiency of the charge.

The long time it takes to charge an electric vehicle is much greater than the time required to fill an equivalent vehicle with fuel. This increase in time is an inconvenience to end users. Generally speaking, charge inlets on electric vehicles use standard wire with insulation to conduct electric current. These wires depend on air movement to expel the heat generated by the current flow in the terminals and wire. In order to decrease the charge time, the electric current must be increased, such as during fast-charging situations. As electric current is passed through a conductive cable, heat is produced. The amount of electric current a wire can carry is limited by the temperature it is allowed to reach. Thus, there is a need for an improved way to store heat generated by electrical wires of a charge inlet for a vehicle during fast-charging situations.

Referring generally to the FIGURES, disclosed herein is a connector assembly for a vehicle charging system that includes a phase change material (PCM) disposed around electrical wires to absorb heat generated by the wires and temporarily store the heat at a relative constant temperature. The connector assembly further includes a first housing that defines one or more charge ports of the vehicle charging system and a second housing coupled to the first housing behind the charge ports. The second housing is configured to receive one or more electrical wires each including a power terminal therein for coupling to an external power source at the charge port of the first housing. The phase change material is disposed in flexible tubes that are coupled to the second housing and surrounds at least a portion of the electrical wires (e.g., wire insulation, conductor, etc.). The phase change material is configured to store heat energy from the electrical wires by direct physical contact between the phase change material and the electrical wires and part of the terminals.

In this manner, the disclosed connector assembly can, advantageously, help to increase efficiency within the connector assembly and reduce charging time for users of the vehicle charging system.

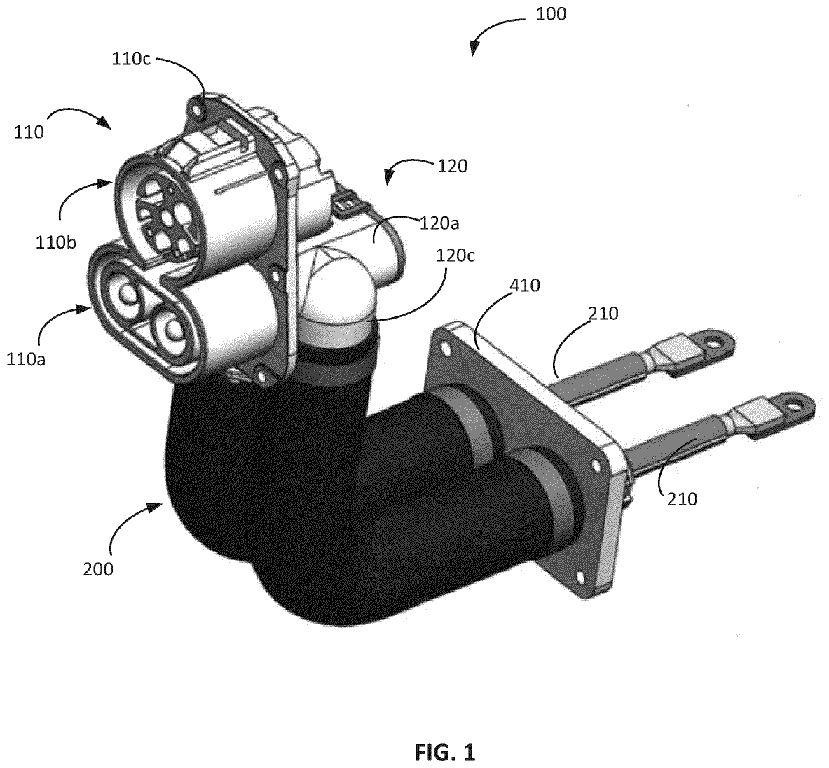

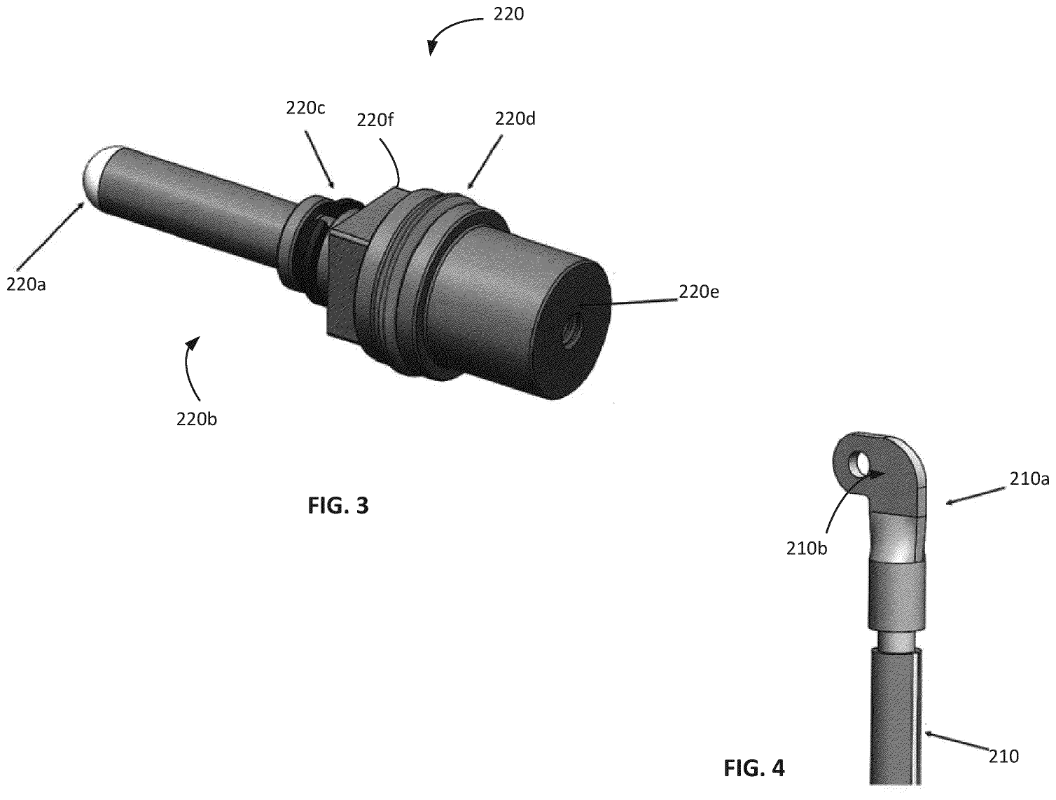

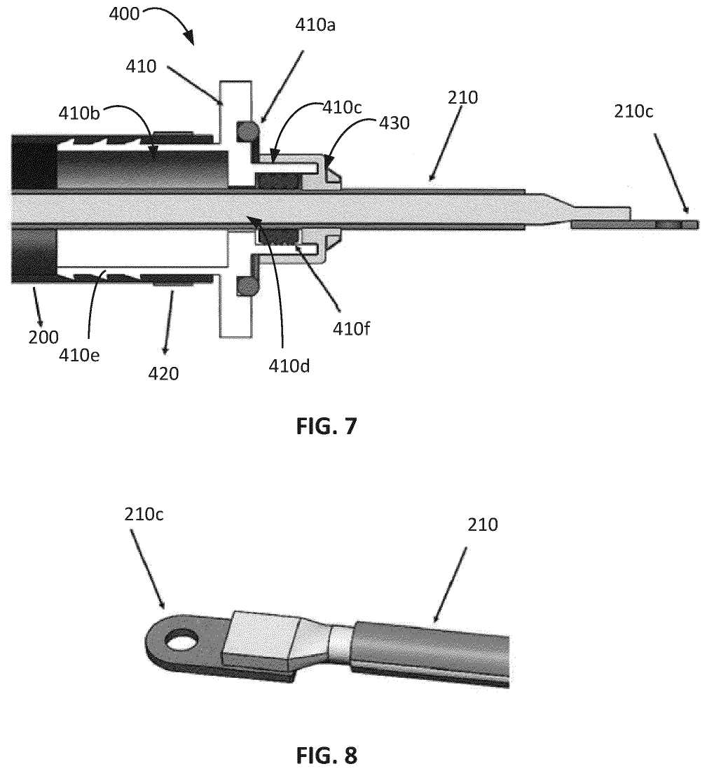

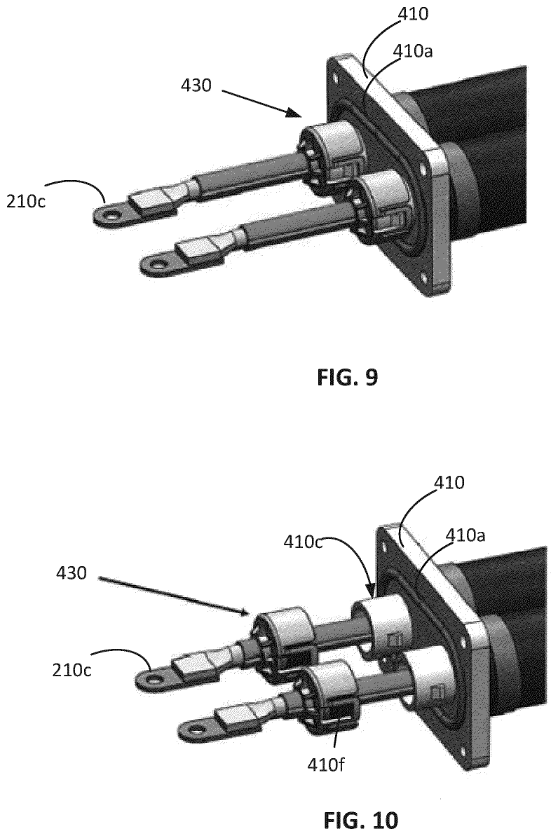

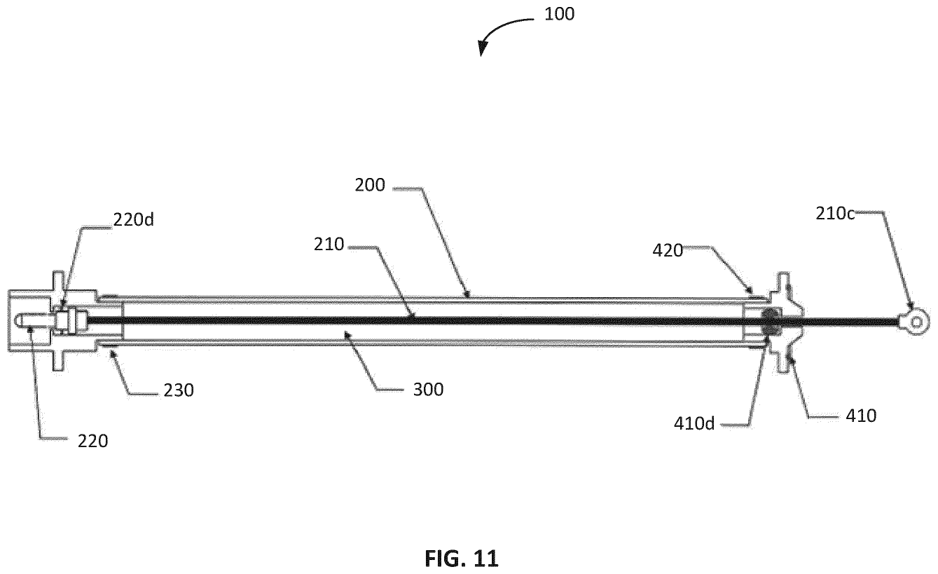

Referring to FIGS. 1-11, a connector assembly 100 for a vehicle charging system is shown according to an exemplary embodiment. The connector assembly 100 includes a first housing 110 defining a first charge port 110a and a second charge port 110b at a front portion of the first housing 110. The first housing 110 may define more or fewer than two charge ports, according to other exemplary embodiments. The first charge port 110a and the second charge port 110b are each configured to receive a charger plug of an external power source to allow current to flow between the external power source and a battery of the vehicle.

The first housing 110 includes a mounting flange 110c disposed behind the first charge port 110a and the second charge port 110b. The mounting flange 110c is configured to couple the first housing 110 to a portion of the vehicle. The first housing 110 further includes a rear portion located opposite the front portion having the first and second charge ports 110a, 110b. The first housing 110 defines a first opening 110d and a second opening (not shown) each extending from the first charge port 110a and through the mounting flange 110c, to a second housing 120. The first and second housings 110, 120 may be made of a plastic non-conducting resin using standard injection mold and process.

The second housing 120 is coupled to the rear portion of the first housing 110. The second housing 120 defines a top portion 120a extending from the mounting flange 110c, opposite the first and second charge ports 110a, 110b. The top portion 120a defines two hollow circular channels, terminating with an opening 120b. Bottom portions 120c extend from the underside of the top portion 120a. Although, there are two bottom portions 120c in the embodiment described herein, it should be appreciated that more or fewer than two may be included in the connector assembly 100 according to other exemplary embodiments. Each bottom portion 120c correspond with a channel in the top portion 120a, thus creating a T-shaped passageway throughout the second housing 120. The bottom portions 120c each terminate with an opening 120d.

The connector assembly 100 further includes one or more flexible tubes 200. The flexible tubes may be made from an elastomer or any other flexible polymeric material or combinations of materials. The flexible tubes 200 are hollow tubes defining a cavity 200a therein. The flexible tubes 200 are configured to couple to the bottom portions 120c such that the flexible tubes 200 are disposed around the bottom portions 120c, the opening 120d corresponding with the cavity 200a. Further, the flexible tubes 200 couple to the second housing 120 in a sealed manner. For instance, a coupling mechanism 230 (e.g., a band clamp, interference fit, snap fit, shrink wrap, etc.) is disposed around the flexible tubes 200 when the flexible tubes are disposed around the bottom portions 120c to provide sealing to contain the PCM within the flexible tubes 200 and to keep moisture out. Although the orientation of the flexible tubes 200 as shown includes a bent segment, it should be appreciated that the configuration of the flexible tubes may vary. For instance, the flexible tubes could be substantially vertical or substantially horizontal. The orientation may depend on the vehicle and use with the PCM, as described herein.

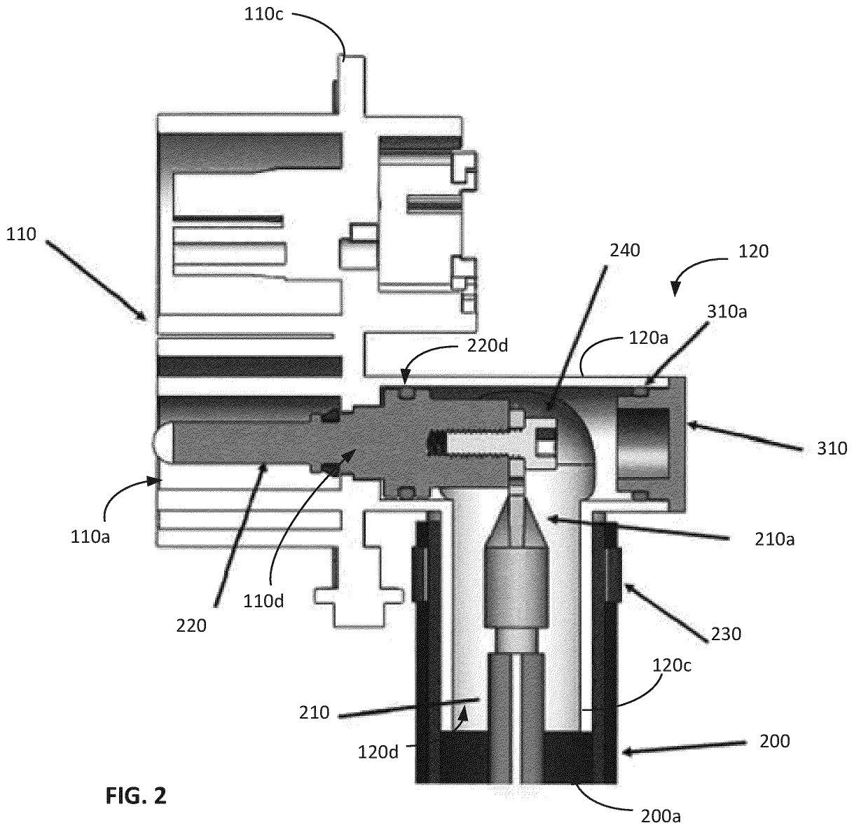

The connector assembly 100 further includes power terminals 220 (i.e., inlet power terminal). The first housing 110 is configured to receive the power terminals 220 through the first opening 110d and the second opening, respectively, such that the power terminals 220 are positioned in the first charge port 110a (see, for example, FIG. 2). The power terminals 220 may be machined from a solid cylinder of copper. In other exemplary embodiments, the power terminals 220 may be other conductive rigid materials. The power terminals 220 have a front contact portion 220a that is used for electrical contact with the charge coupler (not shown) via terminal contacts contained in the coupler device. The front contact portion 220a may have an insulated tip for user safety. The front contact portion 220a may be a separate piece that is assembled to the power terminals 220 so as to be in electrical contact with a body 220b of the power terminals 220. The power terminals 220 also include the body 220b configured to align, attach and seal it to the first housing 110. For instance, as described herein, the body 220b may be configured to fit within the first opening 110d. The body includes a stepped configuration corresponding to the first opening 110d, ending in a retaining wall 220f. The retaining wall 220f is configured to prevent the power terminals 220 from moving away from the second housing 120 once aligned within the first opening 110d. A retaining element 220c is further provided to secure the terminal within the first and second housings 110, 120. The retaining element 220c, shown as a c-clip, may be a clip or an alternative retaining mechanism such as a snap feature, and is disposed on the first housing side when aligned within the first opening 110d. A terminal seal 220d (e.g. o-ring) is disposed around the retaining wall 220f, thus engaging an inner surface of the second housing 120 to provide a seal and help to prevent the interior of the vehicle charging system from being contaminated by the external environment and prevent the PCM from leaking out when the PCM is in a liquid phase. The power terminals 202a also include a rear potion 202e configured to couple to electrical wires 202 in a way that allows electrical conduction. In the embodiment shown, the rear portion 220e contains a threaded hole that receives a bolt 240, so as to couple the electrical wires 202 to the power terminals 220 at the threaded hole. The electrical wires 210 may also be coupled to the second housing 120, such as with snap features, etc.

The electrical wires 210 are disposed through the flexible tubes 200 and into the second housing 120, such that the power terminals 220 for each electrical wire 210 are coupled to a terminal 210a (e.g., an inlet eyelet terminal) of the electrical wire 210 via the bolt 240. The terminal 210a and the power terminals 220 meet perpendicularly within the second housing 120. The terminal 210a includes a flat side 210b with surface area sufficient to interface with the surface area of the rear portion 220e. The terminal 210a may be attached to the electrical wires 210 by welding or crimping (see, for example, FIG. 4).

In the exemplary embodiment of FIGS. 1-11, two conductive wires are shown disposed in respective flexible tubes 200, with one electrical wire 210 attached to the positive terminal and one electrical wire 210 attached to the negative terminal, but it should be appreciated that more or fewer than two electrical wires 210 may be used with the connector assembly 100 according to other exemplary embodiments. The cavity 200a surrounds at least a portion of the electrical wires 210. In the exemplary embodiment of FIGS. 1-11, two flexible tubes 200 are shown, one to surround each electrical wire 210, but it should be appreciated that more or fewer than two flexible tubes 200 may be used with the connector assembly 100 according to other exemplary embodiments. For instance, a single tube could be used to surround both wires together.

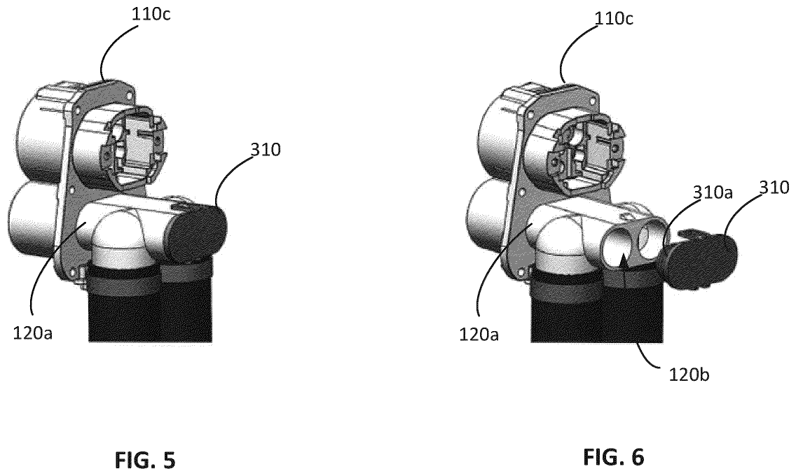

Still referring to FIGS. 1-11, a phase change material (PCM) 300 is disposed in the flexible tubes 200, via cavity 200a, and surrounds at least a portion of each electrical wire 210. The PCM 300 is in direct physical contact with the electrical wires 210 and the flexible tubes 200. According to an exemplary embodiment, during assembly of the connector assembly 100, the PCM 300 is poured or injected into the cavity 200a of the flexible tubes 200 while in the liquid phase, such that the PCM 300 substantially fills the cavity 200a with the electrical wires 210 disposed therein. A cover 310 (e.g., cap, lid, seal, etc.) is provided to couple to the second housing 120. The cover may include a seal 310a (e.g. o-ring). The cover 310 is configured to mate with the opening of the top portion 120a and is removably coupled to the opening (e.g., via snap features, etc.), so as to provide selective access to the each cavity 200a. The cover 130 may be removed to insert the bolt 240 when coupling the terminal 210a to the power terminal 220. Further, the cover 130 facilitates filling the cavity 200a with the PCM 300 when removed. For example, the cover 310 may be seen in a coupled/closed position in FIG. 5 and in a detached/open position in FIG. 6. In the open position, the PCM 300 may be injected into the opening 120b of the top portion 120a such that the PCM 300 flows through the channels of the second housing 120, to the bottom portions 120c and down into the flexible tubes 200. The PCM 300 may be injected into the flexible tubes 200 before the flexible tubes 200 are bent into the vehicle configuration. The PCM 300 may be injected in the liquid (e.g., hot) state, from an opening of a third housing, as explained herein, to accomplish an “air bleed” in one step.

The PCM 300 may be an organic material (e.g., from petroleum, plants, or animals) or a salt hydrate. The PCM 300 may be a hydrocarbon PCM to provide stability for repeated thermal cycles. The PCM 300 may have a high latent heat value and stable thermal cycling. For example, the PCM 300 may be C₃₆H₇₄. The PCM 300 is structured to absorb large amounts of heat energy while melting from a solid to a liquid. Thus, the PCM 300 will absorb the heat energy produced during the charging process when the electrical wires 210 heat up to approximately 50° C.-90 ° C. (e.g., 65° C.-75° C.), and melt the surrounding PCM. The energy is then released back when the PCM 300 begins to return to its solid state. By adding the PCM 300 to the flexible tubes 200, the rate of heat storage of the heat generated by the electrical wires 210 is increased. The PCM 300 will temporarily hold the heat produced by the electrical wires 210 and the power terminals 220 during a DC fast charge cycle. Further, because the PCM is retaining and releasing the heat energy, the electrical wires 210 are able to remain at a relatively constant temperature. In this manner, the connector assembly 100 can, advantageously, increase the efficiency of charging.

Referring still to FIGS. 1-11, a third housing 400 is included. The third housing 400 is configured to attach to the outside of the battery pack (not shown). In the embodiment shown, the third housing 400 has a flange 410 (e.g., insulator) configured to receive bolts that thread into the battery pack outer case. The flange 410 also has a compliant seal 410a that may be compressed to provide sealing during assembly of the flange 410 to the battery pack. The third housing 400 includes first portions 410b and second portions 410c, each extending from the flange 410 in opposite directions. In the embodiment shown, two first portions 410b and two second portions 410c are used, but it should be appreciated that more or less first and second portions 410b, 410c may be included. The two first and second portions 410b, 410c correspond with the two flexible tubes 200 and the two electrical wires 210. The first portions 410b are configured to be received by the flexible tubes 200 such that the electrical wires 210 and the PCM 300 may be disposed within the first portion 410b. The flexible tubes 200 are disposed around the first portion 410b and are configured to be sealed with a coupling mechanism 420 (e.g., a band clamp, interference fit, snap fit, shrink wrap, etc.). Additionally, the first portion 410b may include teeth 410e to grip the flexible tubes 200 and secure the flexible tubes 200 to the third housing 400.

The third housing 400 further includes an opening 410d. The opening 410d is configured to receive only the electrical wires. As such, the flange 410 acts as the first barrier (i.e., seal) for the retaining the PCM, and therefore the heat energy generated by the electrical wires within the connector assembly 100. The third housing 400 includes a cable seal 410f. The cable seal 410f may be a compliant material between the second portions 410c and the electrical wires 210. The cable seal 410f is configured to substantially seal the volume of PCM 300 within the flexible tubes 200 as it is compressed by connectors 430 (e.g., holder, cap, seal, etc.) into the flange 410. The connectors 430 are disposed around the portion of the electrical wires 210 that extend beyond the second side portion of the flange 410 (i.e., the surface the second portions 410c extend from). The connectors 430 may act to substantially seal an end of the cavity 200a to contain the PCM material within the connector assembly 100 by compressing the cable seal 410f, as explained herein. The cable seal 410f may be coupled to an inner surface of the connectors 430 such that the cable seal 410f moves with the connectors 430. The connectors 430 may couple to the second portions 410c using snap features as illustrated. The connectors 430 may also couple via clamps, interference fit, etc., according to other exemplary embodiments. The connectors 430 may be detached from the second portions 410c while the PCM 300 is injected into the flexible tubes 200 to allow for the flexible tubes 200 to be filled and air bled. In the embodiment shown, two connectors 430 are shown, but it should be appreciated that more or less connectors 430 may be included.

The electrical wires 210 terminate at terminal 210c (e.g., battery eyelet terminal). The terminal 210c may be coupled to the electrical wires 210 by welding or crimping (see, for example, FIG. 8). The terminal 210c is on the opposite end of the electrical wires 210 from the terminal 210a. As such, the third housing 400 is on the opposite end of the connector assembly 100 as the first and second housings 110, 120. The terminal 210c is configured to couple directly to the battery power (e.g., the battery may be an 800V-100 kW hr battery).

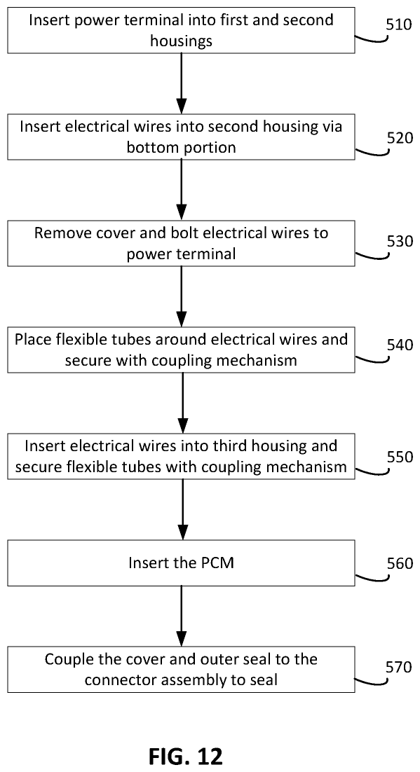

Referring to FIG. 12, a method 500 of assembling the connector assembly 100 is provided. At step 510, the power terminal 220 is inserted into the first housing 110. The retaining element 220c will secure the power terminal 220 in position and the terminal seal 220d will engage with the inner surface of the second housing 120. At step 520, the electrical wires 210 are inserted into the second housing 120 via the bottom portions 120c. At step 530, the cover 310 may be removed to gain visibility and access to screw the bolt 240 through the terminal 210a and the thread of the rear portion 220e to attach the electrical wires 210 to the power terminal 220. At step 540, the flexible tubes 200 are positioned over the electrical wires 210 and the bottom portions 120c. The flexible tubes 200 are each secured to the second housing 120 with the coupling mechanism 230. At step 550, the electrical wires 210 are inserted into the third housing 400 and the flexible tubes 200 are positioned and secured to the first portion 410b of the third housing 400 with the coupling mechanism 230. At step 560, with the cover 310 removed and the connector 430 released, the PCM 300 is injected into the connector assembly 100 in a liquid state, so as to substantially fill the flexible tubes 200 and surround at least a portion of the electrical wires 210. At step 570, the cover 310 may be coupled to the opening 120b and the outer cover coupled to the second portion 410c to substantially seal the connector assembly entirely.

The disclosed connector assembly can, advantageously, help to increase efficiency within the connector assembly and reduce charging time for users of the vehicle charging system by surrounding the electrical wires with a phase change material that will absorb heat generated by the wires, and temporarily store the heat at a relative constant temperature.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition. than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the connector assembly as shown in the various exemplary embodiments is illustrative only. Additionally, any element disclosed in one embodiment may be incorporated or utilized with any other embodiment disclosed herein.

What is claimed is:

1. A connector assembly for a vehicle charging system, the connector assembly comprising:
a first housing defining a charge port of the vehicle charging system and a second. housing coupled to the first housing, the second housing configured to receive an electrical wire including a power terminal therein;
a flexible tube coupled to the second housing and a phase change material disposed therein, the phase change material configured to surround at least a portion of the electrical wire, and the phase change material configured to store heat energy from at least one of the electrical wire or the power terminal; and
a cover coupled to the second housing for facilitating the injection of the phase change material into the flexible tube.
